(19) United States
(12) Patent Application Publication
(10) Pub. No.: US 2004/0240942 A1
(43) Pub. Date: Dec. 2, 2004

(54) Method and system for remediating contaminated soil

(76) Inventor: Roger Todd Richter, Portland, OR (US)

Correspondence Address: MARGER JOHNSON & MCCOLLOM PC, 1030 SW MORRISON STREET, PORTLAND, OR, 97205, US

(21) Appl. No.: 10/478,877

(22) PCT Filed: May 22, 2002
(86) PCT No.: PCT/US02/16395

(51) Int. Cl. B09C 1/00

(52) U.S. Cl. 405/128.35; 405/128.15; 405/128.55; 405/128.8

(57) ABSTRACT

A system and method for remediation of contaminated soil is provided. The system comprises a soil remediation cell of contaminated soil, and a plurality of multi-functional perforated pipes located within the contaminated soil. The multi-functional perforated pipes operate as (a) heating elements for introducing heat into the contaminated soil for volatilizing the contaminants located within the contaminated soil without utilizing mechanically driven forced air thereby producing a contaminated vapor, and (b) flow channels for removing the contaminated vapor from within the soil remediation cell. A high temperature covering, located about the soil remediation cell, forms a chamber over the soil remediation cell which receives and collects in the chamber the contaminated vapor which have been released from the multi-functional perforated pipes. Means for collecting and/or destroying contaminants in the contaminated vapors collected in the storage chamber can also be employed in conjunction with the soil remediation cell.

### BACKGROUND OF THE INVENTION

The invention relates to methods and systems for remediating contaminated soil, and more particularly to a methods and systems for volatilizing contaminants in the soil and effectively and efficiently destroying the same therefrom.

Systems for conducting fluid through a soil stack are known. U.S. Pat. No. 4,139,321 describes a rock channel heat storage method involving conduit connections provided within a rock-filled channel. The conduits are used to conduct fluid through the rock pile to either absorb or disperse thermal energy. Soviet Patent 837,997 describes a method for the thermal treatment of embankment soil. A main hold 3 receives heated combusted gas and directs same into spiral holes 5 which are vented through valves 8. U.S. Pat. No. 4,036,285 describes an arrangement to control heat flow between a member and its environment including conduit members which conduct heat transfer fluid underground. Other patents which show devices for conducting fluid through a soil stack include U.S. Pat. Nos. 123,384; 2,332,227; 2,332,227; 3,105,134; 3,564,862; 3,935,900; 5,449,113; Soviet Union 600,262; Soviet Union 996,662; Fed. Rep. Germany 2,706,740.

Systems for removing contaminants from the ground are also known. For example, U.S. Pat. No. 4,982,788 removes contaminants from the ground by circulating air between two substantially parallel wells and by removing the vapors of the organic compounds from the circulated air using at least one of a condenser and a demister. U.S. Pat. No. 5,011,329 relates to in situ decontamination by injecting a hot gas into boreholes formed in a contaminated soil area. A method is also provided in U.S. Pat. No. 5,018,576 for in situ decontamination of contaminated subsurface areas by injection of steam into injection wells and withdrawing of liquids and vapors from the wells under sub-atmospheric pressure.

Systems have also known for removing contaminants from soil piles or soil stacks. U.S. Pat. No. 4,973,811 relates generally to in situ decontamination of soil using radio frequency induction heating. In U.S. Pat. No. 5,035,537, soil, porous rock, and similar contaminated materials are gathered, dispersed uniformly on a horizontal surface, and treated with an emulsifying agent.

U.S. Pat. No. 5,067,852 relates to a method and apparatus for removing volatile contaminants from contaminated soil which has been stacked onto a first vapor-tight liner. A first set of air distribution pipes disposed within the soil stack each of which has an opened end, a closed end, and a plurality of perforations located in the body of the pipes. An air stream is introduced into the open end of the distribution pipes and exits the distribution pipes through the perforations and into the contaminated soil stack. The air flows from the distribution pipes, through the contaminated soil, and volatilizes contaminants within the contaminated soil. The air flow from the distribution pipes employees a gravel filter medium to prevent the perforations in the distribution pipes from clogging. The volatized vapor created as a result of the induced air flow is carried by the air flow through the soil, and is exhausted from the soil. The volatilized vapors exiting the soil stack are disposed of through an external vapor treatment system. A second vapor-tight liner is placed over the soil stack to creating an impervious enclosure between the respective first and second liners, which are typically formed of a polyethylene film. In order to avoid melting of the first and/or second liners, the temperature of the soil stack would have to be maintained below the melting temperature of the respective liners.

U.S. Pat. No. 5,213,445 and U.S. Pat. No. 5,340,236 are directed to a similar process to U.S. Pat. No. '852 except that they provide a recirculating system which destroys the contaminant phase and returns heated decontaminated air to the air distributions pipes. The air heating unit, which is located outside of the soil stack, heats the air to temperature of between 275 and 300 degrees F.

The above-described methods and systems, which are incorporated herein by reference, have a number of drawbacks. They are closed loop systems which recirculate a substantial portion of the heated air after the contaminants are burned or removed. Recirculation of air through heaters reduces oxygen in the air stream thereby reducing the effective level of volatilization. These systems of U.S. Pat. Nos. '852, '445 and '236 make use of a vacuum to encourage contaminants to achieve vapor phase which has proven to be an ineffective approach for affecting remediation. As previously stated, the temperature of the volatizing air must be maintained below the melting temperature of the sealing member in order maintain its structural integrity. The above prior art systems are designed to move the vaporized contaminants through the soil stack into the space thereabove surrounded by the flexible sealing member. Therefore, the soil cannot be packed down to maintain the structural integrity of the soil stack without adversely effecting the efficiency of the remediation process.

In U.S. Pat. No. 6,000,882 a system and method for remediation of contaminated soil removed from a soil site is provided. The contaminated soil is placed upon several layers of perforated heating pipes forming a remediation cell, and the entire cell is covered by a galvanized Quonset Hut-shaped steel building to prevent the escape of vapors from the soil cell. Forced heating air introduced into perforated heating pipes conductively heats the contaminated soil creating a differential pressure area around the heated pipes. This results in the migration of volatilized contaminants and moisture through the perforations in the pipe walls and into the lower pressure area within the heated steel pipes, forcing a stream of vapor containing the contaminants from the soil and into an off-gas treatment system. The forced air system described in U.S. Pat. No. 6,000,822 generates a substantial volume of heated air which is a burden on capacity and operability of the subject contaminant removal system.

### SUMMARY OF THE INVENTION

The above-described drawbacks have been met by the system and methods of the present invention.

The subject invention is not a closed loop system as indicated in United States Pat. Nos. 5,213,445 and 5,067,832. The system and method of this invention also does not make use of a vacuum to encourage contaminants to achieve vapor phase. The system and method herein are designed to treat both volatile and semi-volatile contaminants as well as a wide variety of soil types (frozen, very wet, high clay content, etc.) And, unlike the prior art systems and methods, in the process and method of this invention, soil can be packed down without decreasing the efficiency of the system.

The system and methods of the present invention also meet the drawbacks of the use of forced heated air as the medium for transporting heat to the contaminated soil and transporting the contaminated vapor away from the contaminated soil. The drawbacks of using forced heated air are as follows:

a. Heated air is a low density medium, and is not the best means of transporting heat. The system of the present invention does not use heated air as the medium for transporting heat to the contaminated soil, and thus does not suffer this shortcoming.

b. Heated air loses heat as it flows, and therefore does not deliver heat evenly. The system of the present invention does not use heated air as the medium for transporting heat to the contaminated soil, and thus does not suffer this shortcoming.

c. Heated air commingles with the contaminated offgas extracted from the contaminated soil, and therefore must also be treated. The system of the present invention does not use heated air as the medium for transporting heat to the contaminated soil, and thus does not suffer this shortcoming.

d. There is an excessive volume of exhaust air generated as compared to the exhaust air of the present invention. The system of the present invention produces a substantially lesser volume of exhaust air. For example, a system of the present invention introduces no heated air and produces about 1000 cfm of heated exhaust offgas air; to perform a similar contaminant removal function requires a forced heated air system utilizing 3000 cfm input of heated air and producing a 3500 cfm volume of exhaust offgas air.

More specifically, a system for remediation of contaminated soil is provided. The system employs a soil remediation cell of contaminated soil, and a plurality of multi-functional perforated pipes located within the contaminated soil. The system can comprise a remediation cell which can be multi-layered and formed of a plurality of adjacent layers of contaminated soil, and a plurality of multi-functional perforated pipes are located between the adjacent layers of contaminated soil. Preferably, the multi-functional perforated pipes are arranged in a substantially horizontal plane with respect to the horizontal axis of the remediation cell.

In another preferred assembly, the multi-functional perforated pipes are arranged in a substantially vertical plane with respect to the horizontal axis of the remediation cell. In this latter configuration, the multi-functional perforated pipes are preferably introduced into the in-ground contaminate soil, and are disposed in a substantially vertical plane with respect to the horizontal axis of the remediation cell, after the formation of the remediation cell. Furthermore, activated carbon can be added to the multi-functional perforated pipes for the purpose of collecting off gases within the confines of the perforated pipes.

Nominal sizes of multi-functional pipes, and materials of construction thereof, can be changed to achieve differing desired results for different treatment needs. For example, smaller sized pipes contain a lower air volume. This results in better conduction of heat in the remediation cell because air is an insulator, and increased amounts of air reduce the conduction effect required in the remediation process.

The multi-functional perforated pipes operate in several ways. They act as heating elements for introducing heat into the contaminated soil for volatilizing the contaminants located within the contaminated soil. The heat is preferably produced by an electrical current.

The second functional of the multi-functional perforated pipes provides a path for removing the contaminated vapor from within the multi-layer soil remediation cell through the multi-functional perforated pipes. Preferably, this second functional is accomplished by conductively heating the contaminated soil with the high temperature infrared heat which converts the contaminants to a vapor, and thereby moving the contaminated vapors produced into and through the multi-functional perforated pipes. The multi-functional perforated pipes provide flow channels for removing the contaminated vapor from within the soil remediation cell. By removing the contaminated vapor from within the soil remediation cell through the multi-functional perforated pipes the contaminants are expurgated from the contaminated soil.

Preferably, the contaminated vapors move into and through the multi-functional perforated pipes, and into the chamber, due to a pressure differential created by the heat introduced into, and generated within, the contaminated soil. Also, it is preferred that the amount of contaminated vapor that flows from the multi-functional perforated pipes into the chamber is controlled by the amount of the heat introduced into the contaminated soil.

Preferably, the multi-functional perforated pipes operate for

introducing the heat using a heating source located within the confines of the pipes. Also, the multi-functional perforated pipes can operate as a source for introducing the heat into the contaminated soil by applying electrical current directly to the pipes.

Then, heat, which is preferably infrared heat, is introduced through heating elements into the contaminated soil by conduction through the walls of the multi-functional, perforated pipes. Preferably, the multi-functional, perforated pipes, and the soil as well, can be heated to a temperature of between about 500 and 1800 degrees F., preferably between about 600 and 1600 degrees F., more preferably between about 700 and 1500 degrees F., and most preferably between about 800 and 1400 degrees F.

Elevated temperatures may even be employed depending on the temperature limitations of the multi-functional perforated pipes and heating elements and the covering. Thus, in cases where a multi-functional perforated pipes and covering are used which can withstand extremely high temperatures, i.e., from about 2,000 up to 3,000 degrees F., a corresponding extremely high temperature heat can be employed. In this way, the first functional can be imparted to the contaminated soil, namely, volatilizing the contaminants located within the contaminated soil thereby producing a pressurized, contaminated vapor.

The temperature of the heat may alternatively be introduced at a lower temperature level, preferably from between 220 and 500 degrees F., for a more extended residence time period of from about 24 to 72 hours, for purposes of volatilizing the contaminants.

A constant level of soil remediation is preferably maintained in the system by either a substantially fixed heat introduction rate or a substantially fixed heat temperature. The system of the present invention can therefore include means for controlling the amount of contaminated vapor that flows from the multi-functional perforated pipes into the vapor collection pipe/system by way of adjusting the temperature of the heating elements within the multi-functional perforated pipes and the vapor collection pipes/system.

The contaminated soil, after the contaminated vapor is removed from within the remediation cell, typically has an average moisture level of not more than about 5% by weight, preferably not more than about 4% by weight, more preferably not more than about 2% by weight, and most preferably not more than about 1% by weight.

Also, a high temperature covering can be located about the soil remediation cell which is capable of withstanding the heat generated by the contaminated vapors from the perforated pipes. Vapors do not move through the soil to the top of the soil cell but rather into the perforated pipes, down the pipes, along the heating elements and into the vapor hold chamber formed between the cell and the covering. This covering forms a chamber over the soil remediation cell which receives and collects in the chamber the contaminated vapor which have been released from the multi-functional perforated pipes. Preferably, the high temperature covering comprises a pressurized metal containment shield, such as a steel-fabricated containment shield, for energy recovery. Also, the contaminant shield, preferably comprises a plurality of arc-shaped sections joined one to the other. A high temperature, insulated containment shield is preferably provided about the soil remediation cell, having an entry opening at one end of the covering in communication with the vapor collection system.

Means can also be provided for collecting and/or destroying contaminants in the contaminated vapors collected in the storage chamber. The contaminated vapor can be destroyed outside the confines of the remediation cell. This is accomplished preferably using an off-gas collection system. The collected contaminated vapor can be released from the storage chamber into the atmosphere or into a secondary treatment system. In another preferred embodiment of this invention, the contaminated vapor can be destroyed within the confines of the remediation cell. In any case, the contaminated vapors are not recirculated to the soil remediation cell.

The system of present invention is typically designed so that the contaminated vapors pass through the exit opening without recirculating the vapors to the multi-layer soil remediation cell. In other words, the subject system is preferably configured for a single-pass remediation operation.

The system can, if desired, further include vapor collection pipes which connected to each of the individual multi-functional perforated pipe within the multi-layer soil remediation cell for providing a path for the contaminated vapors or off-gases. Preferably, these vapor collection pipes can be buried within the center of the soil remediation cell. They can also run the length of the soil cell. Each vapor collection pipe can have a plurality of multi-functional perforated pipe connections extending therefrom to the sides of the soil cell.

The heating effect produced by the system of the present invention results in a substantial increase in uniform, even heating in the remediation cell, particularly when compared to the use of forced heated air as the heating mechanism. Control of heating using electrical current can be accomplished automatically across zones within the cell in a much more standardized approach to contaminant remediation.

Furthermore, the invention described herein is not limited in remediation cell depth, length and width. Forced air heating, on the other hand, is constrained by the extent to which it can affect the remediation process and the limitations imposed by the necessity of routing the high volumes of off-gases. Conversely, the subject method and system will remediate the soil in the remediation cell to a level well beyond that which can be achieve using driven forced air.

In performing this volatilization function, it can be accomplished without utilizing mechanically driven forced air to produce a heat and/or offgas vapor transport mechanism. Typically, the system of this invention has a sound level and a dust level in the area of the remediation cell which are substantially reduced due the absence of substantial equipment in a system having substantial moving mechanical parts. Due to a pressure differential created by the high temperature vapors within the contaminated soil, this system can operate without any moving parts to move air because it is not the air moving through the soil which volatilized the contaminants but rather the conductive heating of the soil.

### DESCRIPTION OF THE DRAWINGS

FIG. 1 is a schematic, broken side view of the system 1 of the present invention.

FIG. 2 is a schematic end of the system 1 of FIG. 1 taken along line 2-2.

FIG. 3 is an enlarged, broken sectional view of a multi-functional perforated pipe 14a.

FIG. 4 is a schematic end of another system 1′ of the present invention.

### DETAILED DESCRIPTION OF A PREFERRED EMBODIMENT

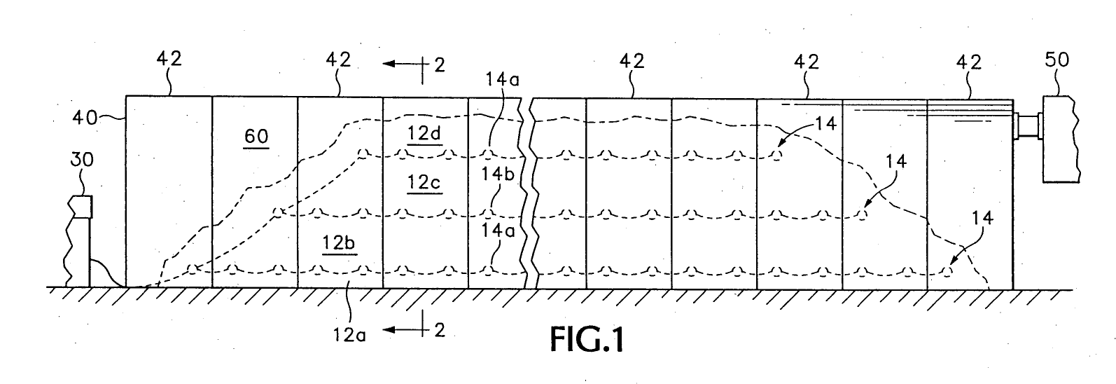

Referring to FIGS. 1-4, systems 1 and 1′ are provided for remediation of contaminated soil which is removed from or stored at a soil site.

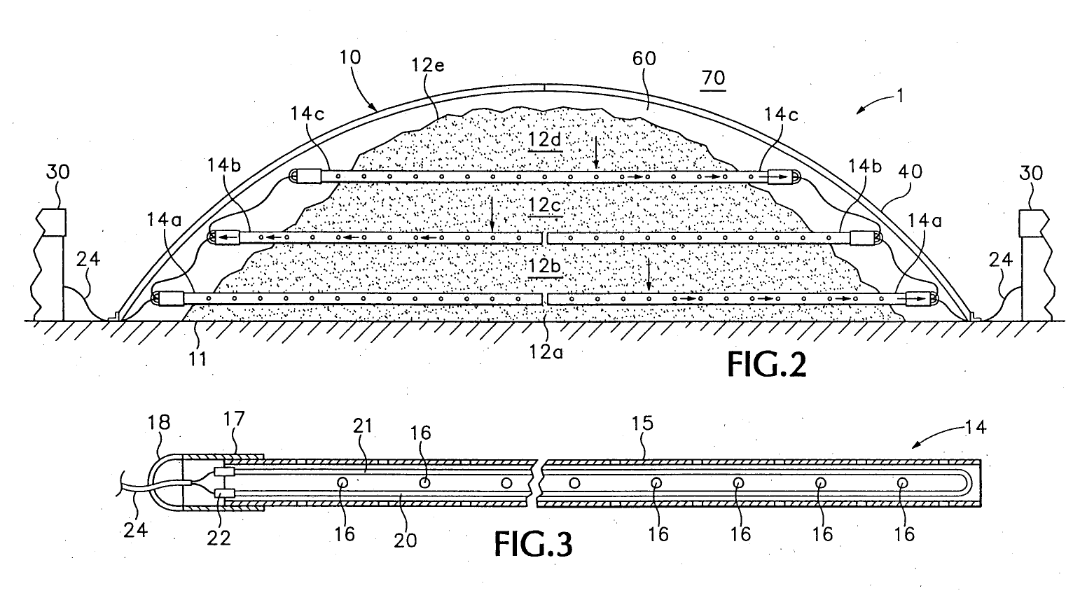

Referring to FIGS. 1 and 2, the system 1 of the present invention can comprise a multi-layer soil remediation cell 10 formed of a plurality of adjacent layers of contaminated soil 12a-12d, having a plurality of dual-function perforated pipes 14a-14c located between the adjacent contaminated soil layers. System 1 can be formed by placing a polymeric liner sheet 11, typically a polyethylene liner, on the ground. Generally a rectangular work area, such as a 36′×80′ area, is laid out. A first layer of contaminated soil 12a is placed upon the liner sheet 11. A soil layer twelve inches thick, for example, can be employed for this purpose. Multi-functional perforated pipes 14a preferably in the form of 3″ steel heating prods, are placed on, and extend outwardly of the first layer of soil 12a.

A second layer of soil 12b (30″ thick) is placed upon the multi-functional perforated pipes 14a. Multi-functional perforated pipes 14b are placed upon the second layer of soil 12b in the manner described above.

A third layer of soil 12c (30″ thick) is placed upon the multi-functional perforated pipes 14b. Multi-functional perforated pipes 14c are similarly placed upon the third layer of soil 12c.

A fourth layer of soil 12d (18″ thick) is placed upon the multi-functional perforated pipes 14c. It is understood that the quantity, size and relative configuration, etc., of the multi-functional perforated pipes and soil layers can vary depending on circumstances involved in a given remediation situation.

Finally, in the example using electric heating elements, the electric heating elements are inserted into the multi-functional perforated pipes and connected to the power panels. In the example using the multi-functional perforated pipes directly as the heating elements, the multi-functional perforated pipes are connected to the power panels.

An insulated metal containment shield 40 is assembled in 4′ arc-shaped sections and forms a covering for the entire soil cell. The temperature range of the heated vapors can reach up to 1800 degrees F. without compromising the integrity of the sealing member.

Distribution power panels 30 are located adjacent the soil remediation cell. Preferably, a 480-volt, 3-phase power panel is employed. The panel 30 is preferably rated at least for 500 amps. The panel 30 supplies power for heating element 20 to heat the pipes 14a-14c.

High temperature heat is produced inside the multi-functional perforated pipes 14a-14c at temperatures up to about 1800 degrees F. The multi-functional perforated pipes are typically manufactured from stainless steel (approximately 20 gauge) so to prevent damage from heavy equipment and/or settling of the contaminated soil 12a-12d.

Referring to FIG. 3, multi-functional pipes denotes “14” which are shown as pipes 14a-14c in FIG. 2., comprise a perforated probe section 15 including perforations 16. One end of probe is joined to an end of cylindrically-shaped end cap 17. The other end of end cap 17 is joined to a pull loop 18. The probe 15, end cap 17 and pull loop 18 are typically fabricated from the same material, typically a metallic material such as stainless steel or the like.

A heating element 20 is located within the confines of probe 15. The heating element 20 is preferably rated at least about 4000 watts. The heating element 20 is typically an elongated loop structure 21 fabricated of a magnesium oxide material with a metal coating and having electrical connectors 22 attached thereto. An electrical wire 24 is connected at one end to the electrical connectors 22 of heating element 20, and at the other end (see FIG. 2) to power distribution panel 30.

A secondary off-gas treatment unit 50 is employed, if necessary, to destroy the contaminants in the contaminated vapor stream. The off-gas treatment unit 50 is in communication with the insulated metal containment shield 40. A blower, not shown, such as a 25 HP, 3-phase, 220 volt Dayton blower can be employed to draw the contaminated air out of the insulated metal containment shield 40, and through a catalytic bed or oxidation chamber (not shown). It is then vented to the atmosphere. A typical blower should be capable of producing 500-1500 CFM air delivery at 12 inches of static pressure.

This system 10 is designed to allow treatment of soil cells of 25 cubic yards to 1500 cubic yards (and greater) in volume. The entire system 1 can be loaded upon a 45 foot flatbed trailer to be transported from site to site. Remediation system 1 is characterized by its ability to remediate over 20 tons of soil per hour with no internal moving parts within the soil remediation cell 10.

In operation, heater element 20 is turned on and soil is heated to a desired temperature. The applied heat creates a temperature gradient extending outward from the multi-functional perforated pipe, with the soil closest to the multi-functional perforated pipe being the hottest. As the soil temperature reaches 212 F, the moisture and the contaminants in the contaminated soil immediately adjacent to the multi-functional perforated pipe are converted from a liquid to a gas phase. This vapor is at high pressure and flows into the multi-function perforated pipe, which is the low pressure point within the contaminated soil cell. As a result, the soil immediately adjacent to the multi-functional perforated pipe is dehydrated. The dehydrated soil substantially surrounds the heating pipes 14a-14c. As heat continues to be applied to the contaminated soil, the volume of the area of soil surrounding the multi-functional perforated pipe that reaches 212 F continues to expand. The moisture and the contaminants in the contaminated soil are converted from a liquid to a gas phase at high pressure. The difference in pressure between the respective high and low pressure areas forces contaminated air, depicted as arrows, through dehydrated soil and into the multi-functional perforated pipes 14a-14c where it flows, depicted as arrows, into the storage chamber 60 where it is exhausted into the atmosphere 70 and/or forced into a secondary off-gas treatment unit 50, which is preferably catalytic oxidizer or thermal oxidizer unit.

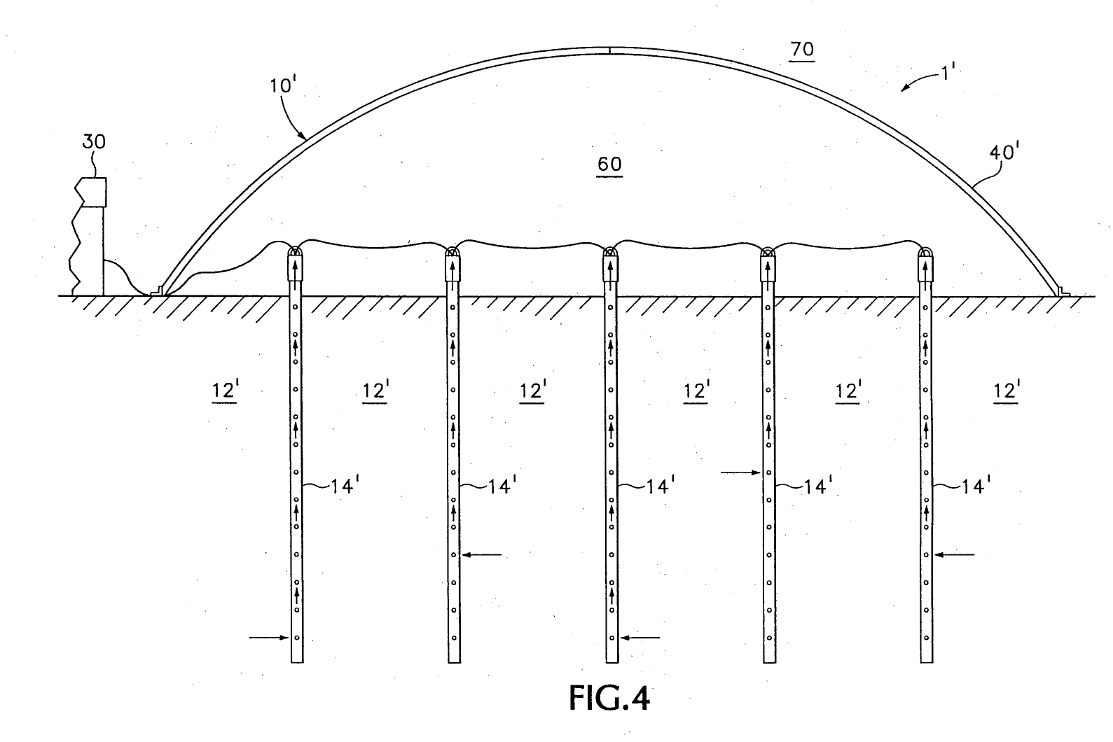

Referring now to FIG. 4, the system 1′ of the present invention can comprise a an in-ground soil remediation cell 10′ formed of contaminated soil 12′, having a plurality of multi-functional perforated pipes 14′ are arranged in a substantially vertical plane with respect to the horizontal axis of remediation cell 10′. Multi-functional perforated pipes 14′ are similar in construction and operation to above-described multi-functional perforated pipes 14a-14c. Pipes 14′ are introduced into the contaminated soil, and are disposed in a substantially vertical plane with respect to the horizontal axis of said remediation cell 10′, after the formation of said remediation cell 10′.

An insulated metal containment shield 40′ is assembled in 4′ arc-shaped sections and forms a covering for the entire soil cell. Shield 40′ are similar in construction and operation to shield 40 above.

Heating elements (not shown) are located inside the multi-functional perforated pipes 14′. These heating elements are similar in construction and operation as heating elements 20 above.

A secondary off-gas treatment unit 50 is employed, if necessary, can be employed, as described above, to destroy the contaminants in the contaminated vapor stream.

In operation, the heating elements are turned on and soil is heated to a desired temperature. Heat and water produce steam which creates high pressure areas in contaminated soil 12′. This contaminated soil is then dehydrated by the conversion of moisture and contaminants in the contaminated soil from a liquid to a gas phase and evacuation of the gas through the multi-function perforated pipes to form areas of lower pressure dehydrated soil. The dehydrated soil substantially surrounds the heating pipes 14′. The difference in pressure between the respective high and low pressure areas forces contaminated air, depicted as arrows, through dehydrated soil and into the multi-functional perforated pipes 14′ where it flows, depicted as arrows, into the storage chamber 60. The contaminated vapor can be exhausted into the atmosphere 70 and/or forced into a secondary off-gas treatment unit (not shown) such as the treatment unit 50 described above.

Having illustrated and described the principles of my invention in a preferred embodiment thereof, it should be readily apparent to those skilled in the art that the invention can be modified in arrangement and detail without departing from such principals. I claim all modifications coming within the spirit and scope of the accompanying claims.

I claim:

1. A system for remediation of contaminated soil, comprising:
a soil remediation cell of contaminated soil, and a plurality of multi-functional perforated pipes located within said contaminated soil,
said multi-functional perforated pipes operating as (a) heating elements for introducing heat into the contaminated soil for volatilizing the contaminants located within the contaminated soil without utilizing mechanically driven forced air thereby producing a contaminated vapor, and (b) flow channels for removing said contaminated vapor from within said soil remediation cell;
a high temperature resistant covering, located about said soil remediation cell, forming a chamber over said soil remediation cell which receives and collects in said chamber said contaminated vapor which have been released from said multi-functional perforated pipes; and
means for collecting and/or destroying contaminants in said contaminated vapors collected in said storage chamber.

2. The system of claim 1, wherein the contaminated vapors moves into and through the multi-functional perforated pipes, and into the chamber due to a pressure differential created by the heat introduced into, and generated within, the contaminated soil.

3. The system of claim 1, wherein the temperature of the heat introduced into the contaminated soil is between 500 and 1800 degrees F.

4. The system of claim 1, wherein the temperature of the heat from about 220 to 500 degrees F, and for volitalizing the contaminants for at least about 24 to 72 hours.

5. The system of claim 1, wherein the contaminated soil is heated to an average temperature greater than about 212 degrees F.

6. The system of claim 1, wherein the contaminated soil, after removing said contaminated vapor from within said remediation cell, has an average moisture level of not more than about 5% by weight.

7. The system of claim 1, wherein the amount of contaminated vapor that flows from the multi-functional perforated pipes into the chamber is controlled by the amount of said heat introduced into said contaminated soil.

8. The system of claim 1 wherein said heat is produced by an electrical current.

9. The system of claim 1, wherein the contaminated vapor is destroyed within the confines of said remediation cell.

10. The system of claim 1, wherein said contaminated vapors are notrecirculated to said soil remediation cell.

11. The system of claim 1, which has a sound level and a dust level in the area of the remediation cell which are substantially reduced due the absence of substantial equipment in the system having moving mechanical parts.

12. The system of claim 1, wherein a substantial constant level of soil remediation is maintained in the system due to either a substantially fixed heat introduction rate or a substantially fixed heat temperature.

13. The system of claim 1, wherein said remediation cell is multi-layered and formed of a plurality of adjacent layers of contaminated soil, and a plurality of multi-functional perforated pipes are located between the adjacent layers of contaminated soil.

14. The system of claim 1, wherein multi-functional perforated pipes are arranged in a substantially horizontal plane with respect to the horizontal axis of said remediation cell.

15. The system of claim 1, wherein multi-functional perforated pipes are arranged in a substantially vertical plane with respect to the horizontal axis of said remediation cell.

16. The system of claim 1, wherein multi-functional perforated pipes are introduced into said in-ground contaminate soil, and are disposed in a substantially vertical plane with respect to the horizontal axis of said remediation cell, after the formation of said remediation cell.

17. The system of claim 1, wherein said high temperature covering comprises a pressurized metal containment shield for energy recovery.

18. The system of claim 1, wherein said multi-functional perforated pipes operate for introducing said heat using a heating source located within the confines of said pipes.

19. The system of claim 1, wherein said multi-functional perforated pipes operate as a source for introducing said heat into the contaminated soil by applying electrical current to said pipes.

20. The system of claim 1, wherein the contaminated vapor is destroyed outside the confines of said remediation cell.

21. A method for remediating contaminated soil, comprising:
forming a soil remediation cell of contaminated soil, and a plurality of multi-functional perforated pipes located within said contaminated soil;
introducing into said contaminated soil said multi-functional perforated pipes comprising (a) heating elements for introducing heat into the contaminated soil for volatilizing the contaminants located within the contaminated soil without utilizing mechanically driven forced air thereby producing a contaminated vapor, and (b) flow channels for removing said contaminated vapor from within said soil remediation cell without using an applied vacuum to extract the contaminated vapor;
providing a high temperature covering, located about said soil remediation cell, forming a chamber over said soil remediation cell which receives and collects in said chamber said contaminated vapor which have been released from said multi-functional perforated pipes; and
providing a chamber for collecting and/or destroying contaminants in said contaminated vapors.

22. A method for expurgating contaminants from contaminated soil, which comprises:
forming a soil remediation cell of contaminated soil, and a plurality of multi-functional perforated pipes located within said contaminated soil;
introducing into said contaminated soil said multi-functional perforated pipes comprising (a) heating elements for introducing heat into the contaminated soil for volatilizing the contaminants located within the contaminated soil without utilizing mechanically driven forced air thereby producing a contaminated vapor, and (b) flow channels for removing said contaminated vapor from within said soil remediation cell;
providing a high temperature covering, located about said soil remediation cell, forming a chamber over said soil remediation cell which receives and collects in said chamber said contaminated vapor which have been released from said multi-functional perforated pipes;
providing a chamber for collecting and/or destroying contaminants in said contaminated vapors.
removing said contaminated vapor from within said soil remediation cell through said multi-functional perforated pipes thereby expurgating said contaminants from said contaminated soil.

23. A system for remediation of contaminated soil, comprising:
an in-ground soil remediation cell of contaminated soil;
a plurality of multi-functional perforated pipes arranged in a
substantially vertical plane with respect to the horizontal axis of said remediation cell located within said in-ground contaminated soil;
said multi-functional perforated pipes operating as (a) heating elements for introducing heat into the contaminated soil for volatilizing the contaminants located within the contaminated soil, without utilizing mechanically driven forced air, thereby producing a contaminated vapor, and (b) flow channels for removing said contaminated vapor from within said soil remediation cell;
a high temperature covering, located about said soil remediation cell, forming a chamber over said soil remediation cell which receives and collects in said chamber said contaminated vapor which have been released from said multi-functional perforated pipes.

24. A method for remediating contaminated soil, comprising:
forming an in-ground soil remediation cell of contaminated soil;
providing a plurality of multi-functional perforated pipes arranged in a substantially vertical plane with respect to the horizontal axis within said in-ground remediation cell;
introducing into said contaminated soil said multi-functional perforated pipes comprising (a) heating elements for introducing heat into the contaminated soil for volatilizing the contaminants located within the contaminated soil, without utilizing mechanically driven forced air, thereby producing a contaminated vapor, and (b) flow channels for removing said contaminated vapor from within said soil remediation cell;
providing a high temperature covering, located about said soil remediation cell, forming a chamber over said soil remediation cell which receives and collects in said chamber said contaminated vapor which have been released from said multi-functional perforated pipes;
providing a chamber for collecting and/or destroying contaminants in said contaminated vapors.
removing said contaminated vapor from within said soil remediation cell through said multi-functional perforated pipes; and
collecting said contaminated vapor within said chamber.
